(19) United States
(12) Patent Application Publication
(10) Pub. No.: US 2010/0214239 A1
(43) Pub. Date: Aug. 26, 2010

(54) METHOD AND TOUCH PANEL FOR PROVIDING TACTILE FEEDBACK

(75) Inventor: Yi-Hsi Wu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/624,426

(22) Filed: Nov. 24, 2009

Related U.S. Application Data
(60) Provisional application No. 61/154,758, filed on Feb. 23, 2009.

(51) Int. Cl. G06F 3/041; G08B 6/00

(52) U.S. Cl. 345/173; 340/407.2

(57) ABSTRACT

A method and a touch panel for providing a tactile feedback are provided. In the present method, a touch operation acting on the touch panel of an electronic device is detected at first. Then, before outputting the tactile feedback, an output attribute of the tactile feedback is altered according to a behavior of the touch operation. Accordingly, the user may experience different tactile feedbacks while performing different touch operations on the same electronic device.

### CROSS-REFERENCE TO RELATED APPLICATION

This application claims the priority benefit of U.S.A. provisional application Ser. No. 61/154,758, filed on Feb. 23, 2009. The entirety of the above-mentioned patent application is hereby incorporated by reference herein and made a part of specification.

### BACKGROUND OF THE INVENTION

1. Field of the Invention

The present invention relates to a method for providing an operation feedback of an electronic device. More particularly, the present invention relates to a method and a touch panel for providing various tactile feedbacks according to the user operation.

2. Description of Related Art

With development of the touch technique, a touch screen can not only be used as an input interface while displaying images, but also has advantages of low cost and durability, etc., so that it becomes popular in the market. In order to lighten the consumer electronic products, a plurality of manufacturers utilizes the touch screen to substitute a conventional screen for saving a hardware keyboard space, so as to slim the product and provide a larger display area for disposing a large-sized touch screen. For a user, a larger screen can provide a perfect visual enjoyment, and can facilitate operations thereof. Moreover, slimness of the product can also facilitate the user.

When the touch screen is used as an input interface, the user can input characters or instructions through a software input panel (SIP), or touch icons of application program, file, or folder to execute the corresponding functions. In order to notify the user that the electronic device using the touch screen has already received the operation performed by the user, the electronic device will output a tactile feedback accordingly. In today's market, the tactile feedback outputted by one electronic device usually has the same output attribute. That is, not matter how diverse the operations are, the electronic device adopts the same feedback manner.

### SUMMARY OF THE INVENTION

Accordingly, the present invention is directed to a method for providing a tactile feedback which outputs the tactile feedback with different attributes according to different touch operations.

The present invention is directed to a touch panel which generates different kinds of tactile feedbacks.

The present invention provides a method for providing a tactile feedback, suitable for an electronic device having a touch panel. Firstly, a touch operation acting on the touch panel is detected. Then, varied output attributes of the tactile feedback are provided according to different behaviors of the touch operation.

According to an embodiment of the present invention, wherein the output attributes comprise at least one of a vibration time, a vibration speed, and a vibration amplitude, a combination with a visual indication and a combination with a vocal indication.

According to an embodiment of the present invention, wherein the step of providing the varied output attributes according to the different behaviors of the touch operation includes following steps. A force of the touch operation on the touch panel is detected at first. And the output attribute of the tactile feedback is provided according to the force if the force exceeds a first force threshold.

According to an embodiment of the present invention, wherein the step of providing the output attribute of the tactile feedback according to the force includes providing the output attribute of the tactile feedback according to a value or a variation of the force.

According to an embodiment of the present invention, wherein the step of providing the varied output attributes according to the different behaviors of the touch operation includes following steps. Firstly, a force of the touch operation on the touch panel is detected. Then, a single position or at least one position of the touch operation on the touch panel is obtained if the force exceeds a first force threshold. After that, the output attribute of the tactile feedback is provided according to a type of the touch panel and the single position or the at least one position, and then the tactile feedback is outputted.

According to an embodiment of the present invention, wherein the step of providing the output attribute according to the type of the touch panel and the single position or the at least one position includes determining whether the single position is corresponding to a specific virtual button when the type of the touch panel belongs to a single-touch panel, obtaining a predetermined virtual button attribute related to the specific virtual button if the single position is corresponding to the specific virtual button, and using the predetermined virtual button attribute as the output attribute and then outputting the tactile feedback.

According to an embodiment of the present invention, wherein after the step of outputting the tactile feedback, the method further includes following steps. First, whether the touch operation exists continuously is determined. If the touch operation exists continuously, whether the touch operation moves to another position is determined. If the touch operation moves, whether a current position of the touch operation is corresponding to an interaction button is determined. A predetermined interaction button attribute related to the interaction button is obtained if the current position is corresponding to the interaction button. Finally, the predetermined interaction button attribute is used as the output attribute and then the tactile feedback is outputted.

According to an embodiment of the present invention, wherein the step of providing the output attribute according to the type of the touch panel and the single position or the at least one position includes following steps. When the type of the touch panel belongs to a multi-touch panel, whether the touch operation is consistent with a specific gesture is determined according to the at least one position. Then, a predetermined gesture attribute related to the specific gesture is obtained if the touch operation is consistent with the specific gesture. Finally, the predetermined gesture attribute is used as the output attribute, and then the tactile feedback is outputted.

According to an embodiment of the present invention, wherein the step of determining whether the touch operation is consistent with the specific gesture further includes determining whether a currently launched application program of the electronic device is a specific application program, and determining whether the touch operation is consistent with the specific gesture if the currently launched application program is the specific application program.

According to an embodiment of the present invention, wherein the step of providing the output attribute according to the type of the touch panel and the single position or the at least one position further includes determining whether the force exceeds a second force threshold, and providing the output attribute according to the type of the touch panel and the single position or the at least one position only if the force exceeds the second force threshold.

The present invention also provides a touch panel for providing a tactile feedback. The touch panel comprises a surface, a behavior determining unit, and a feedback output unit. Wherein the surface is for receiving a touch operation. The behavior determining unit coupled to the surface is for detecting different behaviors of the touch operation. The feedback output unit coupled to the behavior determining unit is for providing varied output attributes of the tactile feedback according to the different behaviors of the touch operation.

According to an embodiment of the present invention, wherein the feedback output unit comprises a vibration unit, a time altering unit, a speed altering unit and a amplitude altering unit. The vibration unit is for generating a vibration as the tactile feedback according to the output attribute. The time altering unit coupled to the vibration unit is for providing a vibration time of the output attribute. The speed altering unit coupled to the vibration unit is for providing a vibration speed of the output attribute. And the amplitude altering unit coupled to the vibration unit is for providing a vibration amplitude of the output attribute.

According to an embodiment of the present invention, wherein the behavior determining unit comprises a force sensor for detecting a force of the touch operation on the touch panel. The feedback output unit alters the output attribute of the tactile feedback according to the force if the force exceeds a first force threshold.

According to an embodiment of the present invention, wherein the feedback output unit alters the output attribute of the tactile feedback according to a value or a variation of the force.

According to an embodiment of the present invention, wherein the behavior determining unit further comprises a position detecting unit for obtaining a single position or at least one position of the touch operation on the touch panel if the force exceeds the first force threshold. The feedback output unit alters the output attribute of the tactile feedback according to a type of the touch panel and the single position or the at least one position.

According to an embodiment of the present invention, wherein when the type of the touch panel belongs to a single-touch panel, the feedback output unit determines whether the single position is corresponding to a specific virtual button, obtains a predetermined virtual button attribute related to the specific virtual button if the single position is corresponding to the specific virtual button, and uses the predetermined virtual button attribute as the output attribute.

According to an embodiment of the present invention, wherein the feedback output unit determines whether the touch operation exists continuously if the single position is corresponding to the specific virtual button, determines whether the touch operation moves to another position if the touch operation exists continuously, determines whether a current position of the touch operation is corresponding to an interaction button if the touch operation moves, obtains a predetermined interaction button attribute related to the interaction button if the current position is corresponding to the interaction button, and uses the predetermined interaction button attribute as the output attribute.

According to an embodiment of the present invention, wherein when the type of the touch panel belongs to a multi-touch panel, the feedback output unit determines whether the touch operation is consistent with a specific gesture according to the at least one position, obtains a predetermined gesture attribute related to the specific gesture if the touch operation is consistent with the specific gesture, and uses the predetermined gesture attribute as the output attribute.

According to an embodiment of the present invention, wherein the feedback output unit determines whether a currently launched application program of an electronic device having the touch panel is a specific application program, and determines whether the touch operation is consistent with the specific gesture if the currently launched application program is the specific application program.

According to an embodiment of the present invention, wherein the feedback output unit determines whether the force exceeds a second force threshold, and alters the output attribute according to the type of the touch panel and the single position or the at least one position only if the force exceeds the second force threshold.

The present invention also provides a touch panel for providing a tactile feedback. The touch panel comprises a detecting means for detecting a touch operation acting on the touch panel, an altering means for altering varied output attributes of the tactile feedback according to different behaviors of the touch operation, and an outputting means for outputting the tactile feedback.

In the present invention, before outputting the tactile feedback, the output attribute of the tactile feedback is altered according to the behavior of the touch operation performed by a user. Accordingly, the user may experience different tactile feedbacks while performing different touch operations on one electronic device.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a touch panel according to an embodiment of the present invention.

FIG. 1B is a structure sketch of the touch panel according to the embodiment of the present invention.

FIG. 2 to FIG. 7 are flow charts illustrating a method for providing a tactile feedback according to embodiments of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

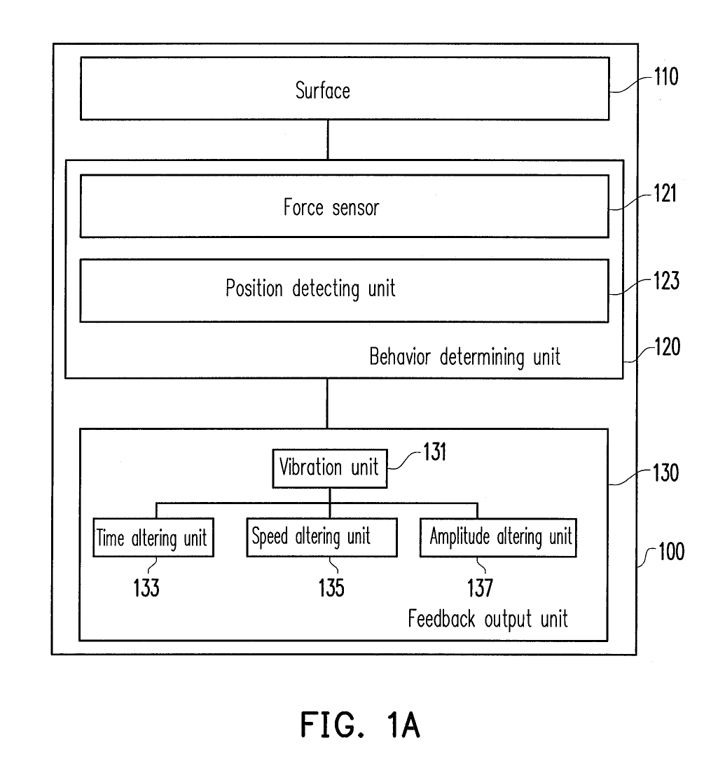

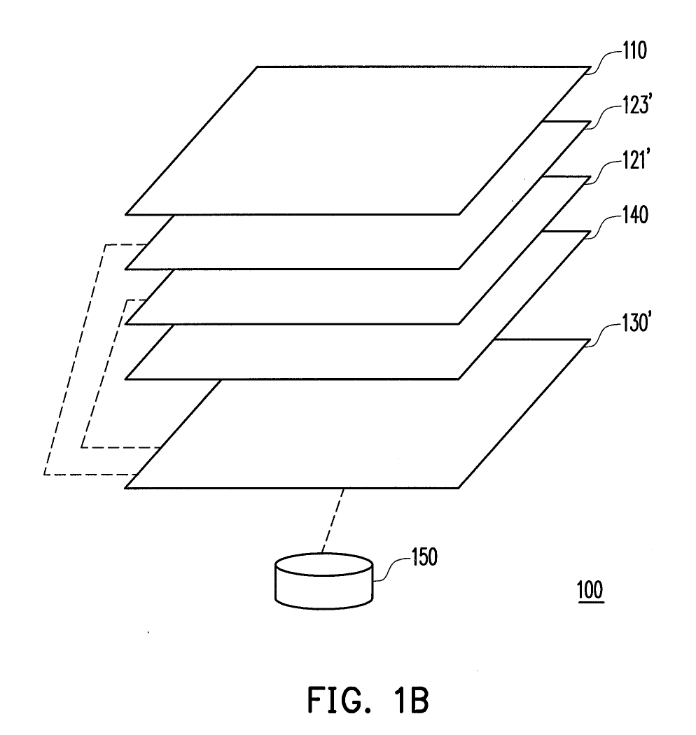

FIG. 1A is a block diagram of a touch panel according to an embodiment of the present invention. Referring to FIG. 1A, a touch panel 100 for providing a tactile feedback comprises a surface 110, a behavior determining unit 120, and a feedback output unit 130. In this embodiment, the touch panel 100 may be used in a cell phone, a personal digital assistant (PDA), a PDA phone, a smart phone, or any other mobile electronic device. However, the scope of the electronic device having the touch panel 100 is not limited herein.

The surface 110 is, for example, a protective shield for protecting the touch panel 100 form being damaged by improper usage. A user can also operate the electronic device having the touch panel 100 by touching the surface 110. When the user touches the surface 110, the surface 110 will correspondingly detect and receive a touch operation. The behavior determining unit 120 coupled to the surface 110 detects a behavior of the touch operation by using a force sensor 121, a position detecting unit 123, or both of the force sensor 121 and the position detecting unit 123.

The feedback output unit 130 is coupled to the behavior determining unit 120, which is for altering an output attribute of the tactile feedback according to the behavior of the touch operation. That is, before outputting the tactile feedback to the user, the feedback output unit 130 alters the output attribute of the tactile feedback according to the behavior of the touch operation which is determined by the force sensor 121, the position detecting unit 123, or both of the force sensor 121 and the position detecting unit 123. After accomplishing the alteration, the feedback output unit 130 then outputs the tactile feedback having the altered output attribute.

In this embodiment, the touch panel 100 is composed of several layers, and a layer structure of the touch panel 100 is illustrated in FIG. 1B. Referring to FIG. 1B, the touch panel 100 is composed of the surface 100, a layer 123′ for placing the position detecting unit 123, a layer 121′ for placing the force sensor 121, a LCD display layer 140, a layer 130′ for placing the feedback output unit 130, and a gesture database 150.

It should be mention about that, the order of layers illustrated in FIG. 1B is one embodiment of the present invention. That is, the order of layers can be different in other embodiment of the invention. For example, the order of the layer 123′ and the layer 121′ can be exchanged.

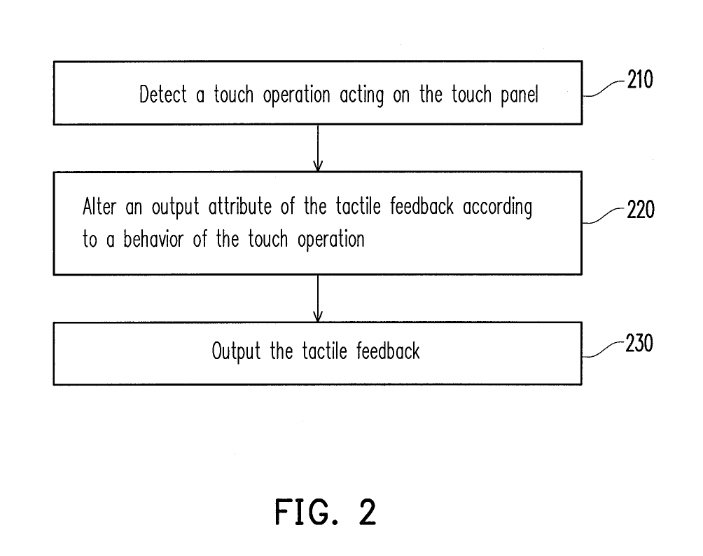

Another embodiment of the present invention will be described in detail in order to further explain the operation of the touch panel 100. FIG. 2 is a flow chart illustrating a method for providing a tactile feedback according to an embodiment of the present invention. Referring to both FIG. 1A, 1B and FIG. 2, in step 210, the surface 110 detects a touch operation while the user touches the touch panel 100, and the behavior determining unit 120 detects a behavior of the touch operation.

For example, the position detecting unit 123 can obtain a single position or at least one position of the touch operation and send the single position or the at least one position to the feedback output unit 130. In one embodiment, the single position or the at least one position can represent the behavior of the touch operation. In another embodiment, since the gesture database 150 records a plurality of relationships between gestures and corresponding positions, the feedback output unit 130 can identify the behavior of the touch operation according to the information obtained by the position detecting unit 123 and the data recorded in the gesture database 150. On the other hand, while the surface 110 receives the touch operation, the force sensor 121 detects a force of the touch operation on the touch panel 100 and sends the detecting result to the feedback output unit 130. And the feedback output unit 130 can identify the behavior of the touch operation according to the force.

Then, in step 220, the feedback output unit 130 alters an output attribute of the tactile feedback according to the behavior of the touch operation. That is, the output attribute of the tactile feedback will be changed according to different user operations. For example, the time altering unit 133 may alter a vibration time of the output attribute, the speed altering unit 135 may alter a vibration speed of the output attribute, and the amplitude altering unit 137 may alter a vibration amplitude of the output attribute.

By controlling the time altering unit 133, the speed altering unit 135 and the amplitude altering unit 137, the feedback output unit 130 can settle at least one of the vibration time, the vibration speed and the vibration amplitude so as to generate tactile feedback with various output attributes corresponding to the behavior of the touch operation. But it should be mention about that, the relationship of the touch operation behavior and the output attribute is not limited in the present invention.

Finally, in step 230, the feedback output unit 130 outputs the tactile feedback having the altered output attribute to the user. In the embodiment, the vibration unit 131 within the feedback output unit 130 generates a vibration as the tactile feedback according to the output attribute. That is, when the behavior determining unit 120 detects different behaviors of the touch operation, the feedback output unit 130 then provides varied output attributes of the tactile feedback according to the different behaviors of the touch operation. As a result, after the user executes the touch operation on the touch panel 100, he/she may experience a corresponding tactile feedback so as to recognize his/her request is accepted by the electronic device having the touch panel 100.

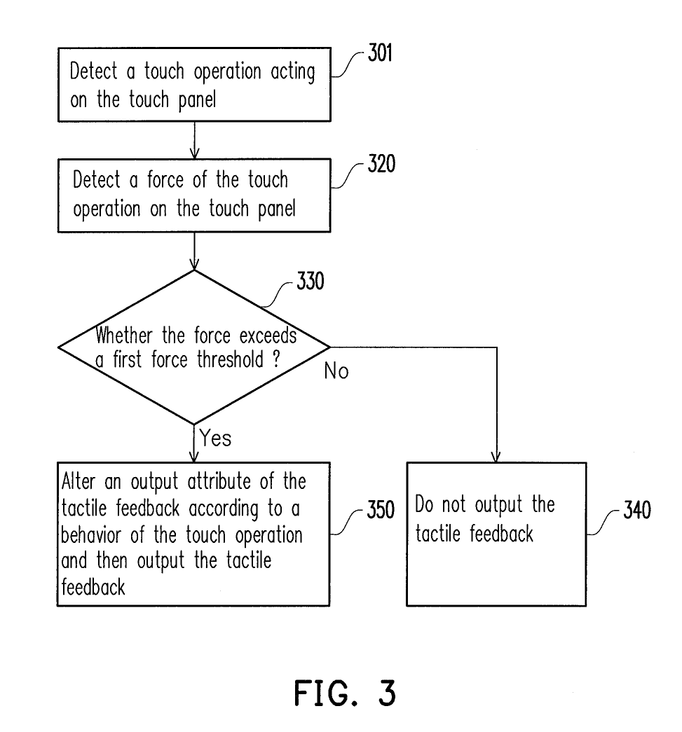

FIG. 3 is a flow chart illustrating a method for providing a tactile feedback according to another embodiment of the present invention. In step 310, the surface 110 detects a touch operation while the user touches the touch panel 100. Next, in step 320, the force sensor 121 of the behavior determining unit 120 detects a force of the touch operation on the touch panel, and transmits the force to the feedback output unit 130.

After receiving the force detected by the force sensor 121, the feedback output unit 130 determines whether the force exceeds a first force threshold in step 330. If the force is less than or equal to the first force threshold, it means that the operation of the user right now may be an accidental touch and the electronic device should not accept the operation. Consequently, in step 340, the feedback output unit 130 does not output any tactile feedback at this situation. On the other hand, if the force exceeds the first force threshold, as shown in step 350, the feedback output unit 130 may control the internal altering units to alter at least one of a vibration time, a vibration speed, and a vibration amplitude of the output attribute according to a value or a variation of the force. For example, the larger value of the force is, the longer vibration time (or the faster vibration speed, the stronger vibration amplitude) will be set. Then, the feedback output unit 130 outputs the tactile feedback consists with the altered output attribute to the user through the vibration unit 131.

In one embodiment, while the user clicks the touch panel 100, the feedback output unit 130 will output the tactile feedback according to the force of the clicking operation. The clicking operation with a strong force may generate a hard vibration feedback.

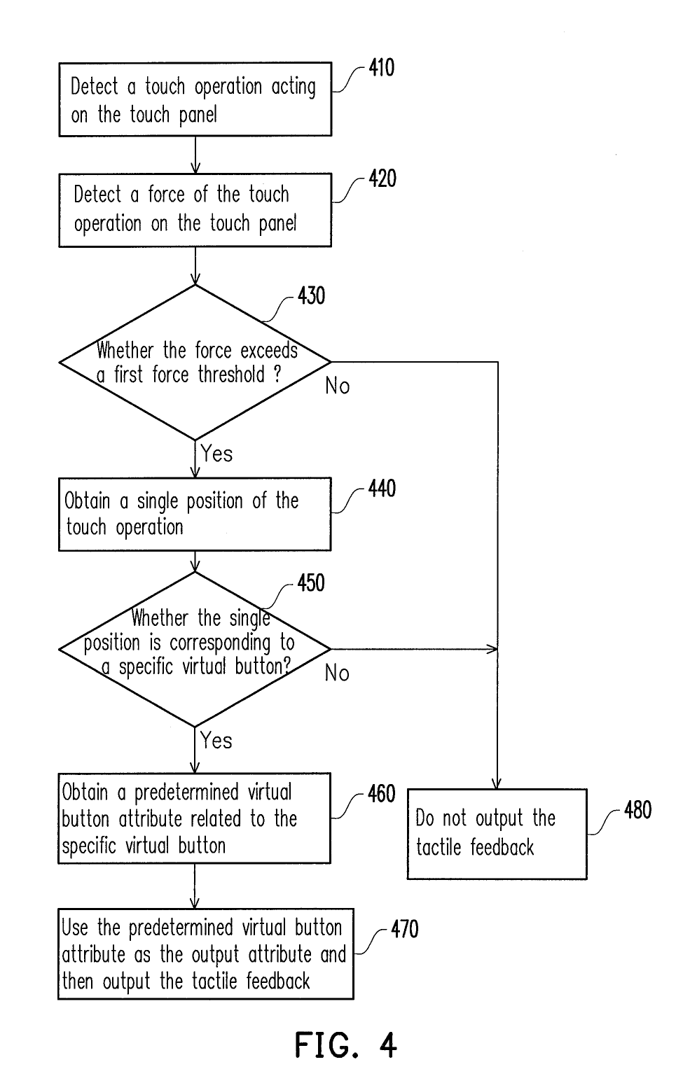

FIG. 4 is a flow chart illustrating a method for providing a tactile feedback according to still another embodiment of the present invention. In this embodiment, assuming that a type of the touch panel 100 belongs to a single-touch panel, and the feedback output unit 130 may alter the output attribute of the tactile feedback according to both of the type of the touch panel and a operating position on the touch panel 110. The steps 410˜430 illustrated in FIG. 4 are the same or similar to steps 310˜330 illustrated in FIG. 3, therefore will not be described herein. After the determination of step 430, if the force detected by the force sensor 121 exceeds the first force threshold, the position detecting unit 123 of the behavior determining unit 120 obtains a single position of the touch operation on the touch panel in step 440, and transmits the single position to the feedback output unit 130.

Then, in step 450, the feedback output unit 130 determines whether the single position is corresponding to a specific virtual button (e.g. a specific icon of an application program, a specific item within a menu, or a specific key on a software input panel). If the single position is not corresponding to any specific virtual button, the feedback output unit 130 does not output any tactile feedback as shown in step 480. However, if the single position is corresponding to a specific virtual button, in step 460, the feedback output unit 130 obtains a predetermined virtual button attribute related to the specific virtual button. Finally, in step 470, the feedback output unit 130 uses the predetermined virtual button attribute as the output attribute and then outputs the tactile feedback to the user. In this embodiment, the position of the specific virtual buttons and the predetermined virtual button attributes respectively corresponding to each of the specific virtual buttons may be stored in an internal storage unit of the touch panel 100. In other embodiment, the position of each of the specific virtual buttons and the related predetermined virtual button attributes may be stored in a storage unit of the electronic device having the touch panel 100.

As shown in FIG. 4, when the user touches a specific virtual button displayed on the touch panel 100, the touch panel 100 will generate a corresponding tactile feedback. That is to say, while the user touches different specific virtual buttons, he/she may experience the tactile feedback with different output attributes.

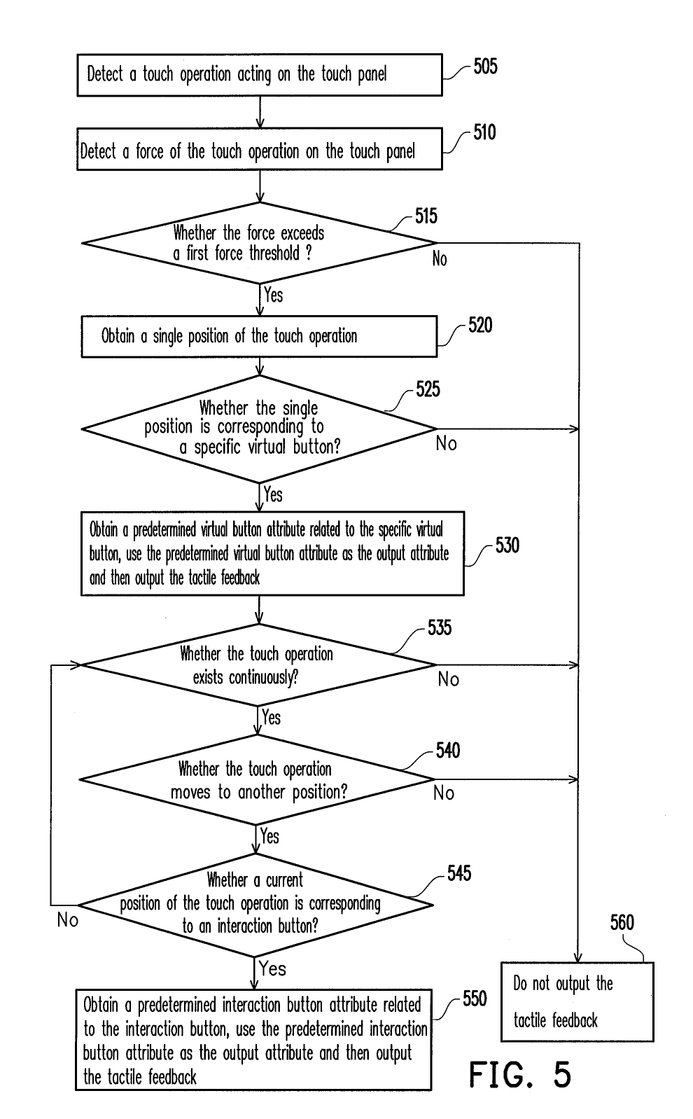

FIG. 5 is a flow chart illustrating a method for providing a tactile feedback according to still another embodiment of the present invention. In this embodiment, assuming that a type of the touch panel 100 belongs to a single-touch panel. Since the steps 505˜530 illustrated in FIG. 5 are the same or similar to steps 410˜470 illustrated in FIG. 4, therefore will not be described herein.

After outputting the tactile feedback according to the specific virtual button, in step 535, the feedback output unit 130 determines whether the touch operation exists continuously. If the touch operation no longer exists, the feedback output unit 130 does not output any tactile feedback as shown in step 560. If the touch operation still exists, the feedback output unit 130 then determines whether the touch operation moves to another position as shown in step 540.

If the touch operation keeps at the same position, the feedback output unit 130 does not output any tactile feedback as shown in step 560. However, if the touch operation moves, the feedback output unit 130 determines whether a current position of the touch operation is corresponding to an interaction button (e.g. a trash can icon) as shown in step 545.

If the current position of the touch operation is not corresponding to any interaction button, the flow of this embodiment will go back to step 535. If the current position of the touch operation is corresponding to the interaction button, in step 550, the feedback output unit 130 obtains a predetermined interaction button attribute related to the interaction button and uses the predetermined interaction button attribute as the output attribute and then outputs the tactile feedback. In this embodiment, the position of each of the interaction buttons and the related predetermined interaction button attribute may be stored in an internal storage unit of the touch panel 100. In other embodiment, the position of each of the interaction buttons and the related predetermined interaction button attributes may be stored in a storage unit of the electronic device having the touch panel 100.

Consequently, while the user touch a specific virtual button displayed on the touch panel 100, he/she may experience the tactile feedback consists with a related output attribute. While the user drags the specific virtual button to a particular position on the touch panel 100 which represents an interaction button, he/she may receive another tactile feedback with the output attribute corresponding to the interaction button.

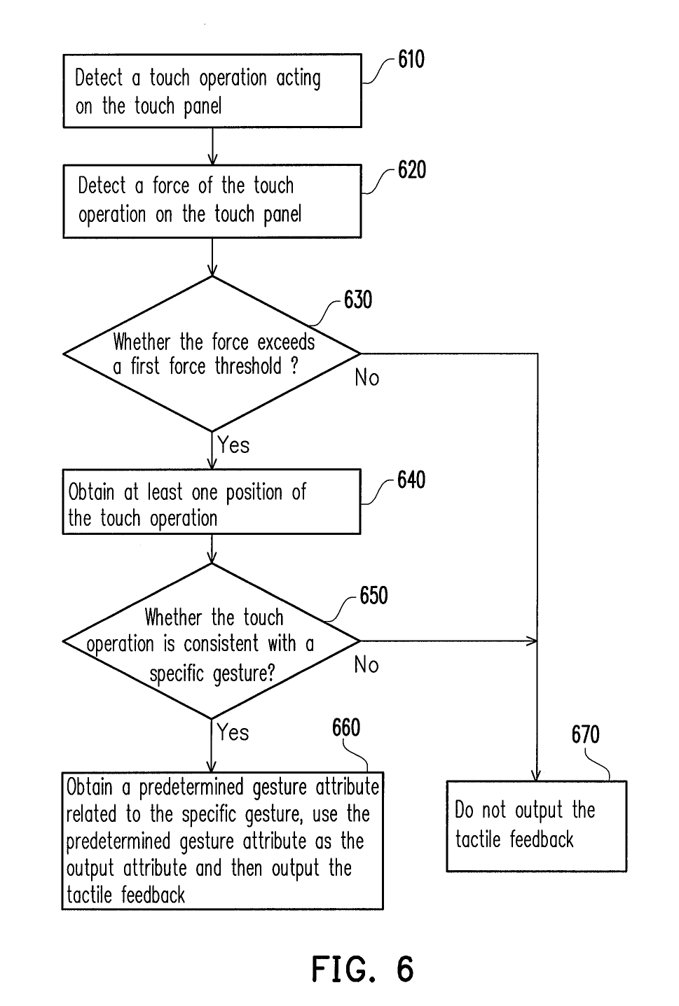

FIG. 6 is a flow chart illustrating a method for providing a tactile feedback according to still another embodiment of the present invention. In this embodiment, assuming that the type of the touch panel 100 belongs to a multi-touch panel, so that the user can use different gestures to operate the electronic device having the touch panel 100.

Referring to FIG. 6, the steps 610˜630 are the same or similar to steps 410˜430 illustrated in FIG. 4 therefore will not be described herein. When the feedback output unit 130 determines the force exceeds a first force threshold, in step 640, position detecting unit 123 of the behavior determining unit 120 obtains at least one position of the touch operation on the touch panel 100.

Next, in step 650, the feedback output unit 130 determines whether the touch operation is consistent with a specific gesture according to the at least one position and the gesture information recorded in the gesture database 150. If the touch operation is not consistent with any specific gesture, the feedback output unit 130 does not output the tactile feedback as shown in step 670.

If the touch operation is consistent with one specific gesture, in step 660, the feedback output unit 130 obtains a predetermined gesture attribute related to the specific gesture, and uses the predetermined gesture attribute as the output attribute then outputs the tactile feedback. In this embodiment, the predetermined gesture attribute may be recorded in the gesture database 150. In other embodiment, the predetermined gesture attribute may be stored in a storage unit of the electronic device having the touch panel 100.

For example, when the feedback output unit 130 identifies that the touch operation is an image magnifying gesture, the feedback output unit 130 may alter the output attribute so as to output a tactile feedback with gradual reduction of intensity.

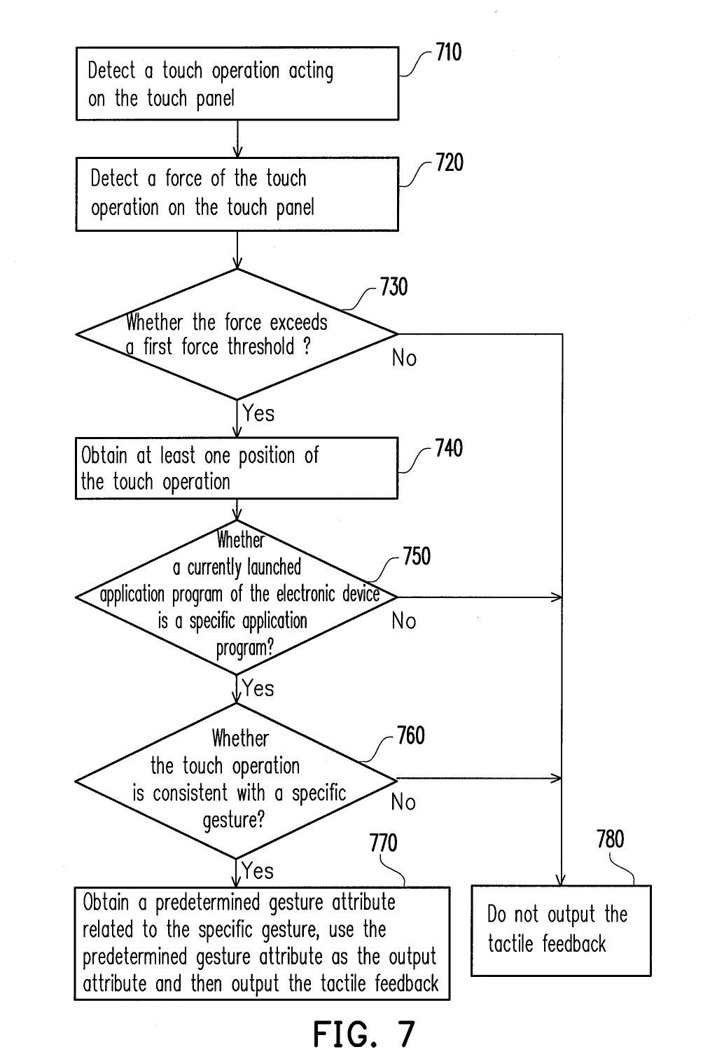

FIG. 7 is a flow chart illustrating a method for providing a tactile feedback according to still another embodiment of the present invention. The steps 710˜740 illustrated in FIG. 7 are the same or similar to steps 610˜640 illustrated in FIG. 6 therefore will not be described herein.

In step 750, the feedback output unit 130 determines whether a currently launched application program of the electronic device having the touch panel 100 is a specific application program. If the currently launched application program is not the specific application program, as shown in step 780, the feedback output unit 130 does not output the tactile feedback.

If the currently launched application program is the specific application program, the feedback output unit 130 then determines whether the touch operation is consistent with the specific gesture in step 760. If the touch operation is not consistent with any specific gesture, the feedback output unit 130 does not output the tactile feedback as shown in step 780. If the touch operation is consistent with the specific gesture, the feedback output unit 130 obtains a predetermined gesture attribute related to the specific gesture, and uses the predetermined gesture attribute as the output attribute then outputs the tactile feedback as shown in step 770.

As illustrate in FIG. 7, only when the specific application program is launched and the user performs the specific gesture, the touch panel 100 will output the related tactile feedback.

In the forgoing embodiments, the feedback output unit 130 alters the output attribute of the tactile feedback according to the type of the touch panel 100 and the single position or the at least one position related to the touch operation. That is, the feedback output unit 130 may output the tactile feedback with different output attributes according to the virtual button touched by the user or according to different user gestures. In the following embodiment, before each time the feedback output unit 130 is about to alter the output attribute, the feedback output unit 130 has to determine whether the force exceeds a second force threshold or not. Only if the force exceeds the second force threshold, the feedback output unit 130 alters the output attribute according to the type of the touch panel and the single position or the at least one position, and than outputs the tactile feedback. That is, the touch panel 100 outputs the related tactile feedback only when the user performs the specific gesture with the strength exceeding the second force threshold.

In view of the above, the present invention provides a method and a touch panel for providing a tactile feedback. According to the above embodiments, the output attribute of the tactile feedback will be altered according to the behavior of the touch operation. That is, different touch operations performed on the touch panel may generate the tactile feedback with different kinds of output attributes. Although the embodiments only describe the tactile feedback, but the other feedbacks (such as visual or vocal feedback) may be combined with the tactile feedback. The visual feedback may includes enlarge or reduce the display, or an indication shown on the display. The vocal feedback may be the guidance or operation indications. Accordingly, the user may have various experiences while operating one electronic device through the touch panel, so that it is much easier for the user to ensure that the electronic device accepts the touch operation correctly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for providing a tactile feedback, suitable for an electronic device having a touch panel, the method comprising:
detecting a touch operation acting on the touch panel; and
providing varied output attributes of the tactile feedback according to different behaviors of the touch operation.

2. The method for providing a tactile feedback as claimed in claim 1, wherein the output attributes comprise at least one of a vibration time, a vibration speed, a vibration amplitude, a combination with a visual indication and a combination with a vocal indication.

3. The method for providing a tactile feedback as claimed in claim 1, wherein the step of providing the varied output attributes of the tactile feedback according to the different behaviors of the touch operation comprises:
detecting a force of the touch operation on the touch panel; and
providing the output attribute of the tactile feedback according to the force if the force exceeds a first force threshold.

4. The method for providing a tactile feedback as claimed in claim 3, wherein the step of providing the output attribute of the tactile feedback according to the force comprises:
providing the output attribute of the tactile feedback according to a value or a variation of the force.

5. The method for providing a tactile feedback as claimed in claim 1, wherein the step of providing the varied output attributes of the tactile feedback according to the different behaviors of the touch operation comprises:
detecting a force of the touch operation on the touch panel;
obtaining a single position or at least one position of the touch operation on the touch panel if the force exceeds a first force threshold; and
providing the output attribute of the tactile feedback according to a type of the touch panel and the single position or the at least one position.

6. The method for providing a tactile feedback as claimed in claim 5, wherein the step of providing the output attribute of the tactile feedback according to the type of the touch panel and the single position or the at least one position comprises:
when the type of the touch panel belongs to a single-touch panel, determining whether the single position is corresponding to a specific virtual button;
obtaining a predetermined virtual button attribute related to the specific virtual button if the single position is corresponding to the specific virtual button; and
using the predetermined virtual button attribute as the output attribute and then outputting the tactile feedback.

7. The method for providing a tactile feedback as claimed in claim 6, wherein after the step of outputting the tactile feedback, the method further comprise:
determining whether the touch operation exists continuously;
determining whether the touch operation moves to another position if the touch operation exists continuously;
determining whether a current position of the touch operation is corresponding to an interaction button if the touch operation moves;
obtaining a predetermined interaction button attribute related to the interaction button if the current position is corresponding to the interaction button; and
using the predetermined interaction button attribute as the output attribute and then outputting the tactile feedback.

8. The method for providing a tactile feedback as claimed in claim 5, wherein the step of providing the output attribute of the tactile feedback according to the type of the touch panel and the single position or the at least one position comprises:
when the type of the touch panel belongs to a multi-touch panel, determining whether the touch operation is consistent with a specific gesture according to the at least one position;
obtaining a predetermined gesture attribute related to the specific gesture if the touch operation is consistent with the specific gesture; and
using the predetermined gesture attribute as the output attribute and then outputting the tactile feedback.

9. The method for providing a tactile feedback as claimed in claim 8, wherein the step of determining whether the touch operation is consistent with the specific gesture further comprises:
determining whether a currently launched application program of the electronic device is a specific application program; and
determining whether the touch operation is consistent with the specific gesture if the currently launched application program is the specific application program.

10. The method for providing a tactile feedback as claimed in claim 5, wherein the step of providing the output attribute of the tactile feedback according to the type of the touch panel and the single position or the at least one position further comprises:
determining whether the force exceeds a second force threshold; and
providing the output attribute according to the type of the touch panel and the single position or the at least one position only if the force exceeds the second force threshold.

11. A touch panel for providing a tactile feedback, comprising:
a surface, for receiving a touch operation;
a behavior determining unit, coupled to the surface, for detecting different behaviors of the touch operation; and
a feedback output unit, coupled to the behavior determining unit, for providing varied output attributes of the tactile feedback according to the different behaviors of the touch operation.

12. The touch panel as claimed in claim 11, wherein the feedback output unit comprises:
a vibration unit, for generating a vibration as the tactile feedback according to the output attribute;
a time altering unit, coupled to the vibration unit, for providing a vibration time of the output attribute;
a speed altering unit, coupled to the vibration unit, for providing a vibration speed of the output attribute; and
an amplitude altering unit, coupled to the vibration unit, for providing a vibration amplitude of the output attribute.

13. The touch panel as claimed in claim 11, wherein the behavior determining unit comprises:
a force sensor, for detecting a force of the touch operation on the touch panel,
wherein the feedback output unit alters the output attribute of the tactile feedback according to the force if the force exceeds a first force threshold.

14. The touch panel as claimed in claim 13, wherein the feedback output unit alters the output attribute of the tactile feedback according to a value or a variation of the force.

15. The touch panel as claimed in claim 13, wherein the behavior determining unit further comprises:
a position detecting unit, for obtaining a single position or at least one position of the touch operation on the touch panel if the force exceeds the first force threshold,
wherein the feedback output unit alters the output attribute of the tactile feedback according to a type of the touch panel and the single position or the at least one position.

16. The touch panel as claimed in claim 15, wherein when the type of the touch panel belongs to a single-touch panel, the feedback output unit determines whether the single position is corresponding to a specific virtual button, obtains a predetermined virtual button attribute related to the specific virtual button if the single position is corresponding to the specific virtual button, and uses the predetermined virtual button attribute as the output attribute.

17. The touch panel as claimed in claim 16, wherein the feedback output unit determines whether the touch operation exists continuously if the single position is corresponding to the specific virtual button, determines whether the touch operation moves to another position if the touch operation exists continuously, determines whether a current position of the touch operation is corresponding to an interaction button if the touch operation moves, obtains a predetermined interaction button attribute related to the interaction button if the current position is corresponding to the interaction button, and uses the predetermined interaction button attribute as the output attribute.

18. The touch panel as claimed in claim 15, wherein when the type of the touch panel belongs to a multi-touch panel, the feedback output unit determines whether the touch operation is consistent with a specific gesture according to the at least one position, obtains a predetermined gesture attribute related to the specific gesture if the touch operation is consistent with the specific gesture, and uses the predetermined gesture attribute as the output attribute.

19. The touch panel as claimed in claim 18, wherein the feedback output unit determines whether a currently launched application program of an electronic device having the touch panel is a specific application program, and determines whether the touch operation is consistent with the specific gesture if the currently launched application program is the specific application program.

20. The touch panel as claimed in claim 15, wherein the feedback output unit determines whether the force exceeds a second force threshold, and alters the output attribute according to the type of the touch panel and the single position or the at least one position only if the force exceeds the second force threshold.

21. A touch panel for providing a tactile feedback, comprising:
a detecting means for detecting a touch operation acting on the touch panel;
an altering means for altering varied output attributes of the tactile feedback according to different behaviors of the touch operation; and
an outputting means for outputting the tactile feedback.
